(19) United States
(12) Patent Application Publication
(10) Pub. No.: US 2018/0186029 A1
(43) Pub. Date: Jul. 5, 2018

(54) MONO-STABLE SELF-ALIGNING TEMPLATE FOR INSTALLING TREATMENTS AND HARDWARE AND METHOD THEREFOR

(71) Applicants: ROBERT BOWERMAN, TUCSON, AZ (US); PAUL MIODUSKI, TUCSON, AZ (US)

(72) Inventors: ROBERT BOWERMAN, TUCSON, AZ (US); PAUL MIODUSKI, TUCSON, AZ (US)

(21) Appl. No.: 15/847,189

(22) Filed: Dec. 19, 2017

Related U.S. Application Data
(60) Provisional application No. 62/440,796, filed on Dec. 30, 2016.

(51) Int. Cl. B27F 5/12; B23B 47/28

(52) U.S. Cl. CPC B27F 5/12; B23B 2247/12; B23B 47/287

(57) ABSTRACT

A mono-stable self-aligning template for installing brackets and treatments around an opening has a first plate having a top surface, a bottom surface, a front edge, a rear edge and a pair of opposing side edges. A plurality of openings is formed through the top surface of the first plate. The plurality of openings is arranged in at least a first array on a first side area on the top surface of the first plate. A mono-stable self-alignment device is coupled to the first plate. The mono-stable self-alignment device is perpendicular to the first plate.

### FIELD OF THE INVENTION

The present invention relates to templates, and more specifically, to a mono-stable self-aligning template device and method to simplify the installation of treatments or other hardware around rectangular opening such as, but not limited to, windows, doors, showers and baths.

### BACKGROUND OF THE INVENTION

There are a number of marking devices for locating holes for mounting window or door treatments around or inside openings. Most of the inventions are directed toward unusual shaped openings or specialty treatments. All of them are somewhat complicated to use and most require some type of adjustment. They are also expensive to produce and not likely to be purchased by homeowners because of the selling price. In the vast majority of cases, the treatment is being installed around or inside a rectangular or square opening and the mounting holes only need to be level with respect to the lintel and symmetric with respect to the sides of the opening. Common examples include but are not limited to drapes, vertical blinds, valances and shower curtains.

The closest prior art, Hafele, U.S. Pat. No. 4,610,092, issued on Sep. 9, 1986, utilizes an alignment mechanism that is bi-stable. FIG. 15A is a simplified version of the prior art, device 80, consisting of plate 82 with an array of one or more holes 83 and plate 81 with vertical alignment surfaces 81B and horizontal alignment surface 81A. FIG. 15B shows an example of a wall opening with surface 100, horizontal edge 100C and vertical edge 100B which is misaligned by angle Φ2. The angular alignment of the template of device 80 can be determined by either the lintel 100C or the side wall 100B because the triangular shaped alignment mechanism is stable in two positions as shown in FIG. 15C and FIG. 15D. The lintel is normally leveled precisely because the proximate ceiling and floor make an error easy to detect. Side walls of most wall openings are often not precisely perpendicular to the lintel. An error of even 2 degrees can produce a substantial vertical error. FIG. 15C shows device 80 aligned with respect to the lintel with edge 81B in contact with edge 100C. Drilling mark 83A is made with device 80 in the afore mentioned position. FIG. 15D shows device 80 aligned with respect to edge 100B with edge 81A in contact with edge 100B. Drilling mark 83B is made with device 80 in the afore mentioned position. FIG. 15B shows the relative positions of drilling mark 83A and 83B with respect to edge 100C and 100B. The following example shows the magnitude of the vertical error ΔV that can be introduced by a bi-stable alignment mechanism that rotates about point 85 where edge 100C meets edge 100B. Using point 85 as the origin, drill mark 83A is located at X=7 in. and Y=1 in. To find ΔV we do the following calculation:

Let: Φ1=2 degrees, drill mark 83A location (X1=7″, Y1=1″). Drill mark 83B (X2, Y2)

Tan Φ2=Y/X=1/7=0.1429

Φ2=arc tan(0.1429)=8.133 degrees

radius(R)=Y/sin Φ2=1/0.1414=7.07 in.

Y2=sin(Φ1+Φ2)*R=sin(2+8133)*7.07=1.24 in

ΔV1=Y2−Y1=1.24−1.0=0.24 in.

In this example, a 2-degree alignment error in vertical edge 100C generated a vertical error ΔV1 of almost ¼ inch. FIG. 15E and FIG. 15F show two examples of a mono-stable alignment mechanism, device 2 and device 5, in an opening with a misaligned side wall 100B. FIG. 15E shows device 2 in its mono-stable position with vertical alignment surface 21E in contact with horizontal edge 100C, horizontal alignment edge 21A in contact with vertical edge 100B, and hole mark 24A made using hole 26. FIG. 15F shows device 5 in its mono-stable position with vertical alignment points 53A and 54A in contact with horizontal edge 100C, horizontal alignment point 54B in contact with vertical edge 100B, and hole mark 56A made using hole 56. ΔV2=0 and ΔV3=0 because device 2 an device 5 each have only one stable position.

Therefore, a need exists to provide a device and method to overcome the above problems of the prior art. The device and method should be a simple device and method that addresses the most common types installations and is inexpensive, self-aligning, mono-stable, and requires no adjustments.

### SUMMARY

In accordance with one embodiment, a mono-stable self-aligning template for installing brackets and treatments around an opening is disclosed. The mono-stable self-aligning template has a first plate having a top surface, a bottom surface, a front edge, a rear edge and a pair of opposing side edges. A plurality of openings is formed through the top surface of the first plate. The plurality of openings is arranged in at least a first array on a first side area on the top surface of the first plate. A mono-stable self-alignment device is coupled to the first plate. The mono-stable self-alignment device is perpendicular to the first plate.

In accordance with one embodiment, a method for installing items around an opening is disclosed. The method comprising: providing a mono-stable self-aligning template comprising: a first plate having a top surface, a bottom surface, a front edge, a rear edge and a pair of opposing side edges; a plurality of openings formed through the top surface of the first plate, the plurality of openings arranged in at least a first array on a first side area on the top surface of the plate; indicia formed next to each of the plurality of openings on both the top and bottom surfaces of the first plate; and a mono-stable self-alignment device coupled to the first plate. The mono-stable self-alignment device being a second plate. The second plate attached to the front edge of the first plate and positioned in front of a second side area of the top surface, the second side area opposite the first side area, the second plate extending an equal distant above and below the front edge, the second plate being perpendicular to the top surface and the rear surface of the first plate; placing the bottom surface of the first plate against a wall where the opening is formed; moving the self-aligning template until the second plate touches an upper ledge of the opening and a right-side ledge of the opening; marking a first drill hole location by inserting a marking device through a selected opening of the plurality of openings; placing the top surface of the first plate against the wall where the opening is formed; moving the self-aligning template until the second plate touches the upper ledge of the opening and a left-side ledge of the opening; and marking a second drill hole location by inserting the marking device through the selected opening of the plurality of openings.

In accordance with one embodiment, a mono-stable self-aligning template for installing brackets and treatments around an opening is disclosed. The mono-stable self-aligning template has a first plate having a top surface, a bottom surface, a front edge, a rear edge and a pair of opposing side edges. A plurality of openings is formed through the top surface of the first plate. The plurality of openings is arranged in at least a first array on a first side area on the top surface of the first plate. Indicia are formed next to each of the plurality of openings on both the front and rear surfaces of the first plate, wherein the indicia formed next to each of the plurality of openings on the front surface matches the indicia formed next to each of the plurality of openings on the rear surface. A mono-stable self-alignment device is coupled to the first plate. The mono-stable self-alignment device being a second plate. The second plate is attached to the front edge of the first plate and positioned in front of a second side area of the top surface. The second side area is opposite the first side area. The second plate extends an equal distant above and below the front edge. The second plate is perpendicular to the top surface and the rear surface of the first plate.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIGS. 1A-1C show different views of a mono-stable self-aligning template device with the lowest tooling cost and moderate production cost in accordance with one aspect of the present application;

FIGS. 2A-2D show different views of a mono-stable self-aligning template device with the lowest production cost but much higher tooling cost in accordance with one aspect of the present application;

FIGS. 3A-3D show different views of another embodiment of the mono-stable self-aligning template device in accordance with one aspect of the present application;

FIGS. 4A-4E show different views of another embodiment of the mono-stable self-aligning template device that can offset the template to meet special requirements, has moderate production cost and has a low shipping and storage profile in accordance with one aspect of the present application;

FIGS. 5A-5G show different views of another embodiment of the mono-stable self-aligning template device that can offset the template to meet special requirements, has low production cost and has a low shipping and storage profile in accordance with one aspect of the present application;

FIGS. 6A-6E show different views of another embodiment of the mono-stable self-aligning template device that is hinged and can fold flat for storage or shipment but has much higher tooling cost and moderate production cost in accordance with one aspect of the present application;

FIGS. 7A-7B show the device of FIGS. 1A-IC being used in a rectangular opening in accordance with one aspect of the present application;

FIGS. 8A-8B shows the device of FIGS. 2A-2D being used in a rectangular opening in accordance with one aspect of the present application;

FIGS. 9A-9B show the device in FIGS. 3A-3D being used in a rectangular opening in accordance with one aspect of the present application;

FIGS. 10A-10B show the device of FIGS. 4A-4E being used in a rectangular opening in accordance with one aspect of the present application;

FIGS. 11A-11B shows the device of FIGS. 5A-5G being used in a rectangular opening in accordance with one aspect of the present application;

FIGS. 12A-12B shows the device of FIGS. 6A-6E being used in a rectangular opening in accordance with one aspect of the present application;

FIGS. 13A-13H illustrates different methods of installing the right end brackets of a treatment around the rectangular opening in accordance with one aspect of the present application;

FIGS. 14A-14H illustrates different method of installing the left end brackets of the treatment around a rectangular opening; and

FIGS. 15A-15F illustrates the accuracy difference between the mono-stable self-alignment device and a bi-stable alignment device in accordance with one aspect of the present application.

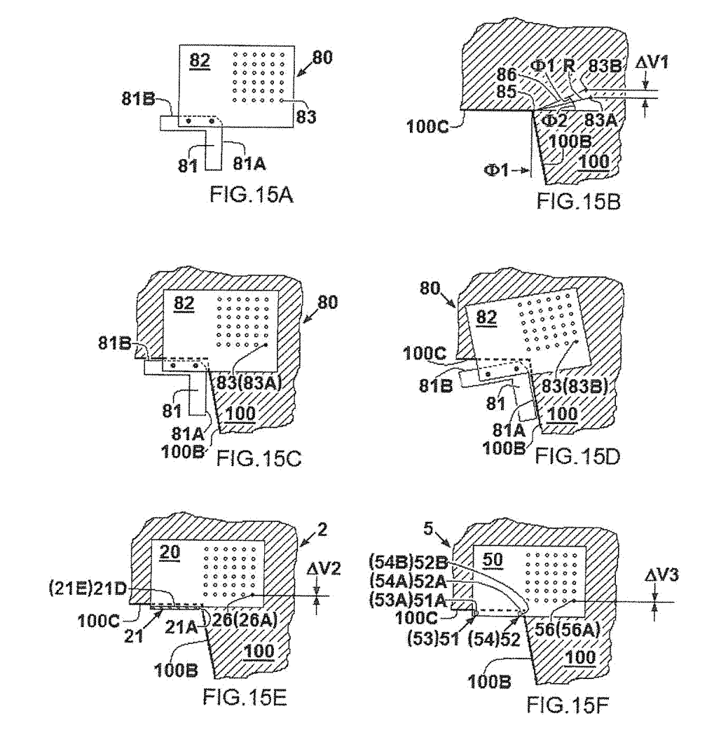

Common reference numerals are used throughout the drawings and detailed description to indicate like elements.

### DETAILED DESCRIPTION

A portion of the disclosure of this patent application contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

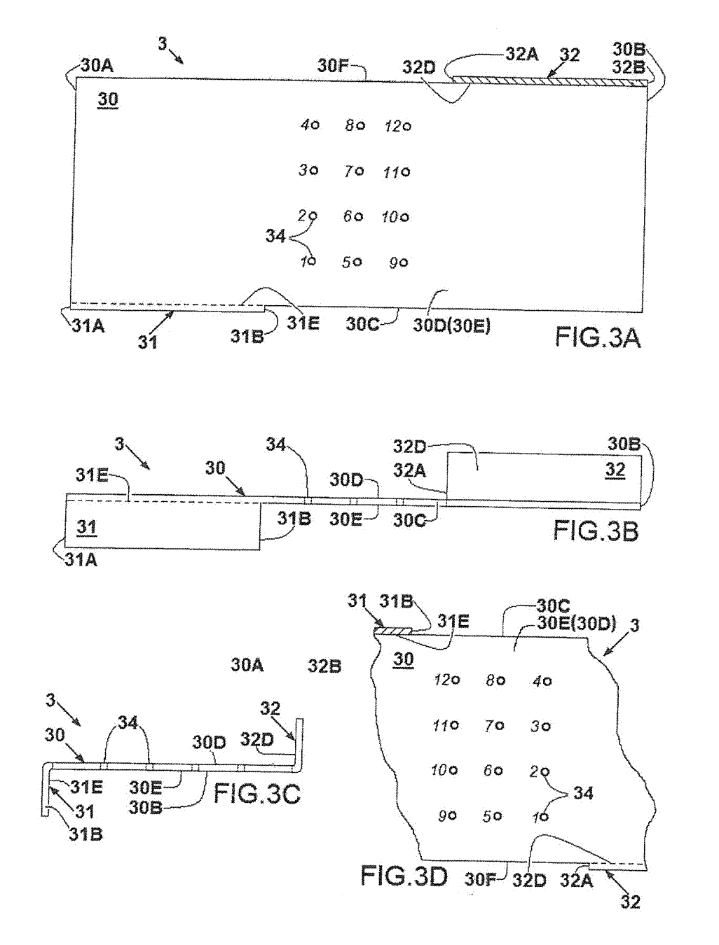

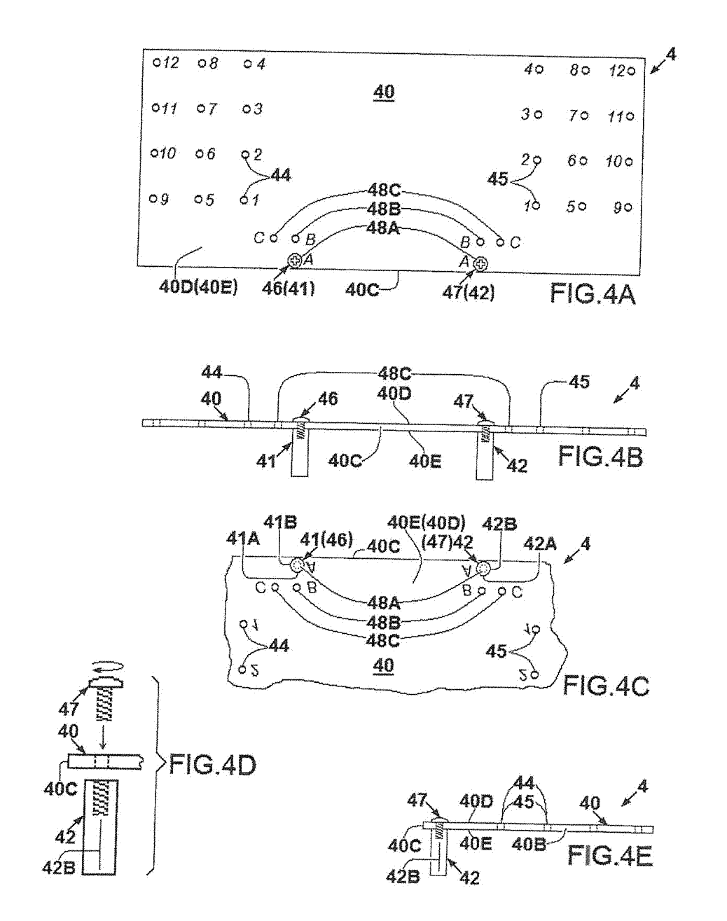

In the following descriptions of various embodiments of this invention, co-located features such as spacers and edges that are not visible in a given drawing view will be labeled in parenthesize next to the indicia of the visible feature that is obscuring it. For example, on sheet 4, FIG. 4A, screw 46 is shown in a hole in plate 40 and is marked 46(41) to indicate that self-alignment spacer 41 is hidden beneath screw 46 in that view. Features of a particular numbered object are named by appending a letter to the name of that object to make it easier to understand. For example, on FIG. 3A, plate 30 has edges 30A, 30B, 30C, 30F and surfaces 30D and 30E. All words used in this disclosure should be interpreted as having the common meaning in the mechanical engineering field unless specifically defined in this document. The term “lintel” refers to the top portion of rectangular opening that is horizontal and parallel to the floor and has an edge which in multiple figures is identified as 100C.

The embodiments disclosed in this document illustrate various ways of implementing the invention which effect tooling cost, production cost, device size, storage size and ease of use. However, all the embodiments utilize the same mono-stable self-aligning mechanism but may be implement in alternative ways. All embodiments have two or more points of contact which determine the vertical position and angle of the template relative to the lintel of the opening and only 1 point of contact in that determines the horizontal position of the template relative to the opening. This improves accuracy, simplifies use and reduces production cost.

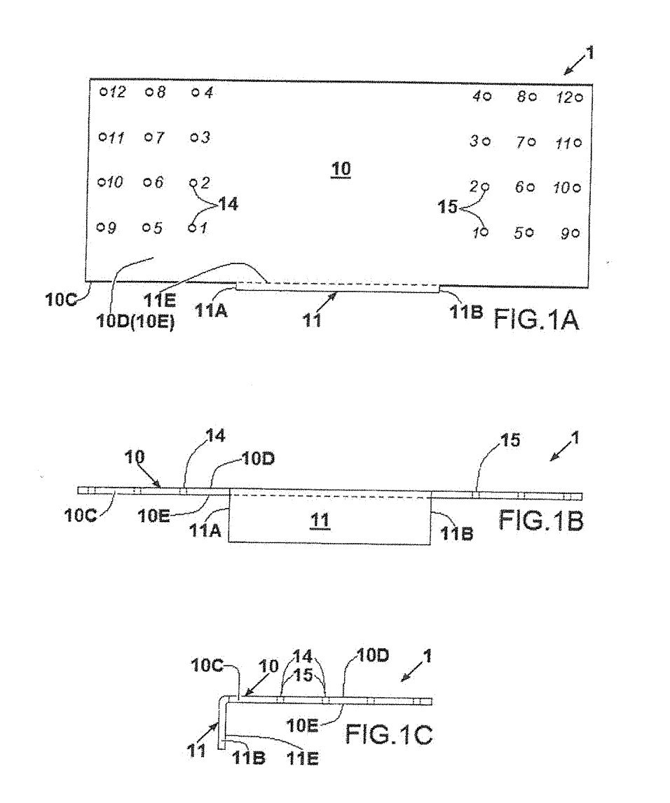

Referring now to FIGS. 1A-1C, one embodiment of the mono-stable self-aligning template device 1 which may have the lowest cost of tooling and simplest operation. Device 1 may consist of a plate 10 and a plate 11. Plate 11 may be perpendicular to plate 10 and may be connected to plate 10 at edge 10C. Plate 11 may be parallel and centered with respect to edge 10C and extend downward and away from surface 100 as shown in FIG. 1B and FIG. 1C.

As may be seen in FIG. 1A in a top view of the plate 10, two arrays of two or more holes, array 14 and array 15, respectively, may be seen. The arrays 14 and 15 may be located symmetrically equidistant from edge 11A and edge 11B of the plate 11. The term “symmetrically equidistant” may be interpreted to mean that the arrays 14 and 15 are a mirror image of each other and placed symmetrically with respect to plate 11 such that array 14 is as far to the left and above edge 11A as the array 15 is to the right and above edge 118, as shown in and FIG. 1A. The holes in arrays 14 and array 15 may be ⅛ inch in diameter, and may be spaced at regular intervals of 0.5 inch or 1.0 inch when sold in the United States or other countries still using SAE measurements. If sold in countries using the metric system or for particular manufacturers products, the hole spacing and size can be varied accordingly. The holes in array 14 and array 15, may be numbered or lettered on surface 10D to indicate the symmetrically corresponding holes in each array. This embodiment of device 1 generally has the lowest tooling cost because it can be fabricated using water jet or laser cutting of low cost sheet plastics such as acrylic or polycarbonate. In this embodiment, plate 10 and plate 11 may be initially attached and co-planer. Lettering or numbering of the holes may be added by screening, ink-jet printing or other equivalent methods before plate 11 is made perpendicular to plate 10 by bending at edge 10C. Although this fabrication method may provide for lowest tooling cost other methods such as injection molding may likely reduce manufacturing cost but may greatly increase tooling cost. For particular applications it may also be advantageous to fabricate device 1 out of aluminum or other metals utilizing CNC punching and bending machines or other equivalent fabrication methods.

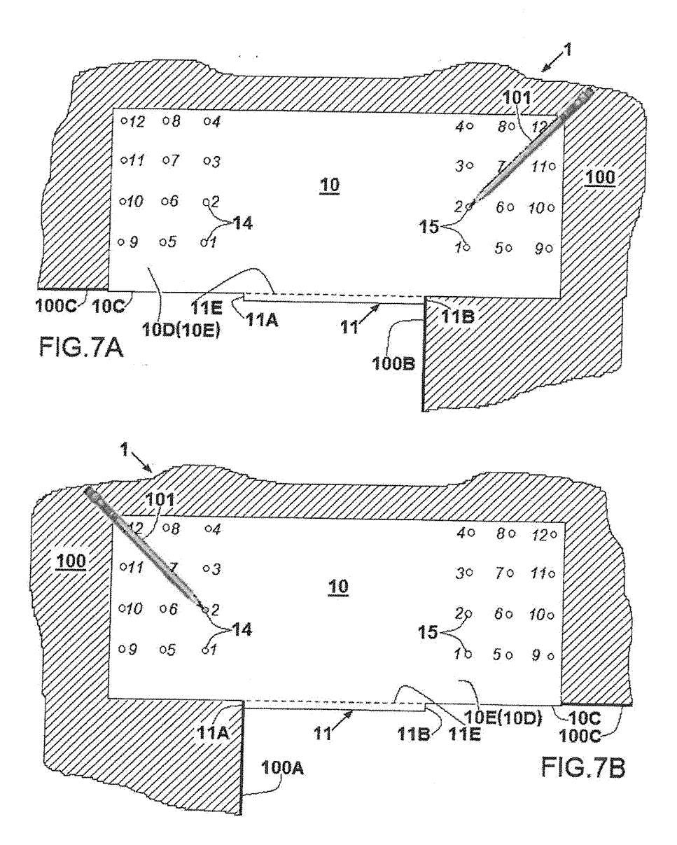

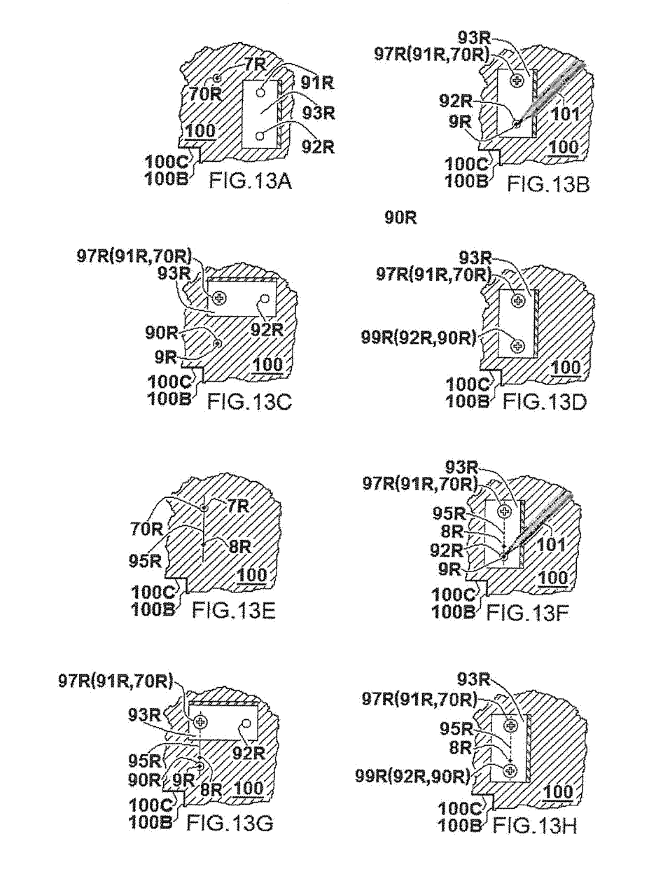

Referring to FIGS. 7A-7B, the use of the mono-stable self-aligning template device 1 on the outside of an opening in a wall may be seen. In FIG. 7A, surface 10E of plate 10 may be placed in contact with the portion of surface 100 that is adjacent to edge 100C. Device 1 may be pushed upwards to position surface 11E of plate 11 in contact with edge 100C and then moved horizontally to the right to position edge 118 in contact with edge 100B. With device 1 in the aforementioned position, marking device 101 may be used to mark the location of the first mounting hole on surface 100: in this example hole 15-2 may be used to locate the position for mark 7R which is above and to the right of the wall opening as shown in FIG. 13A. Hole 70R may then be drilled at location 7R as shown in FIG. 13A. Right mounting bracket 93R may be positioned such that mounting bracket hole 91R is aligned with drilled hole 70R: bracket fastener 97R may be installed through the aligned holes to partially secure the afore mentioned bracket as shown in FIG. 13B. Mounting bracket 93R may be rotated to be perpendicular to the lintel and then marking device 101 may be used to mark the location of the second mounting bracket hole on surface 100: in this example mounting bracket hole 92R may be used to locate the position for mark 9R as shown in FIG. 13B. Mounting bracket 93R may be rotated so that bracket mounting hole 90R can be drilled at location 9R as shown in FIG. 13C. The installation of the right mounting bracket may be completed by rotating it back into a vertical position and aligning bracket hole 92R with drilled hole 90R and securing it with fastener 99R as shown in FIG. 13D. If the mounting bracket had more than two holes, the additional holes may be marked and fastened in the same manner as the second mounting bracket hole as detailed above.

Referring to FIGS. 13E-13H, another method for installing the right mounting bracket, that can improve accuracy, may be seen. To improve accuracy, one may make a second hole mark, either above or below the first hole mark, so a straight line can be drawn as a guide for one or more of the remaining bracket holes. In this example, with device 1 in the same position used to create hole mark 7R, template hole 15-1 could be used in conjunction with marking device 101 to create mark 8R allowing straight line 95R to be drawn through said marks as shown in FIG. 13E. Hole 70R may then be drilled at location 7R as shown in FIG. 13E. Right mounting bracket 93R may be positioned such that mounting bracket hole 91R may be aligned with drilled hole 70R and bracket fastener 97R may be installed through the aligned holes to partially secure the afore mentioned bracket as shown in FIG. 13F. Mounting bracket 93R may be rotated to center bracket mounting hole 92R on line 95R and marking device 101 may be used to create hole mark 9R on surface 100 as shown in FIG. 13F. Mounting bracket 93R may then be rotated so that bracket mounting hole 90R can be drilled at location 9R as shown in FIG. 13G. The installation of the left mounting bracket may be completed by rotating it back into a vertical position and aligning bracket hole 92R with drilled hole 90R and securing it with fastener 99R as shown in FIG. 13H. If the mounting bracket had more than two holes, the additional hole(s) may be marked and fastened in the same manner as the second bracket mounting hole as detailed above.

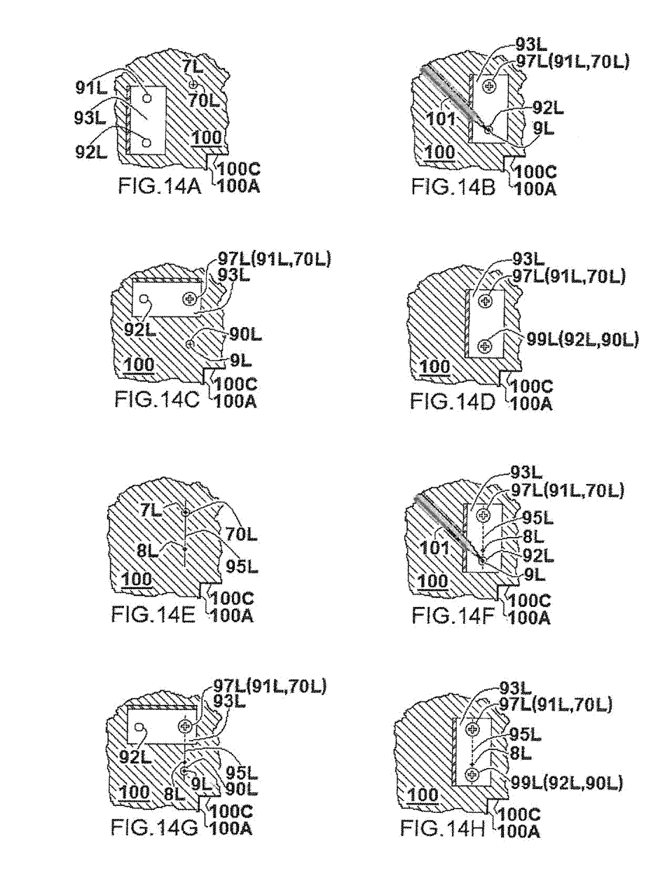

FIG. 7B illustrates how to mark a symmetrically identical hole on the left side of the opening using device 1. In FIG. 7B, surface 10E of plate 10 may be placed in contact with the portion of surface 100 that is adjacent to edge 100C. Device 1 may be pushed upwards to position surface 11E of plate 11 in contact with edge 100C and then moved horizontally to the left to position edge 11A in contact with edge 100A. With device 1 in the afore mentioned position, marking device 101 may be used to mark the desired position of the mounting hole on surface 100: in this example template hole 14-2 may be used to locate mark 7L which is above and to the left of the wall opening as shown in FIG. 14A. Hole 70L may then be drilled at location 7L as shown in FIG. 14A. Left mounting bracket 93L may be positioned such that mounting bracket hole 91L may be aligned with drilled hole 70L and bracket fastener 97L may be installed through the aligned holes to partially secure the afore mentioned bracket as shown in FIG. 14B. Mounting bracket 93L may be rotated to be perpendicular to the lintel and then marking device 101 may be used to mark the location of the second mounting bracket hole on surface 100: in this example mounting bracket hole 92L may be used to locate the position for mark 9L as shown in FIG. 14B. Mounting bracket 93L may then be rotated so that bracket mounting hole 90L can be drilled at location 9L as shown in FIG. 14C. The installation of the left mounting bracket may be completed by rotating it back into a vertical position and aligning bracket hole 92L with drilled hole 90L and securing it with fastener 99L as shown in FIG. 14D. If the mounting bracket had more than two holes, the additional hole(s) may be marked and fastened in the same manner as the second mounting bracket hole as detailed above.

Referring to FIGS. 14E-14F, another method for installing the left mounting bracket may be seen. In order to improve accuracy, one may make a second hole mark, either above or below the first hole mark, so a straight line can be drawn as a guide for one or more of the remaining bracket holes. In this example, with device 1 in the same position used to create hole mark 7L, template hole 14-1 could be used in conjunction with marking device 101 to create mark 8L allowing straight line 95L to be drawn through said marks as shown in FIG. 14E. Hole 70L may then be drilled at location 7L as shown in FIG. 14E. Left mounting bracket 93L may be positioned such that mounting bracket hole 91L may be aligned with drilled hole 70L and bracket fastener 97L may be installed through the aligned holes to partially secure the afore mentioned bracket as shown in FIG. 14F. Mounting bracket 93L may be rotated to center bracket mounting hole 92L on line 95L and marking device 101 may be used to create hole mark 9L on surface 100 as shown in FIG. 14F. Mounting bracket 93L is then rotated so that bracket mounting hole 90L can be drilled at location 9L as shown in FIG. 14G. The installation of the left mounting bracket may be completed by rotating it back into a vertical position and aligning bracket hole 92L with drilled hole 90L and securing it with fastener 99L as shown in FIG. 14H. If the mounting bracket had more than two holes, the additional hole(s) may be marked and fastened in the same manner as the second bracket mounting hole as detailed above.

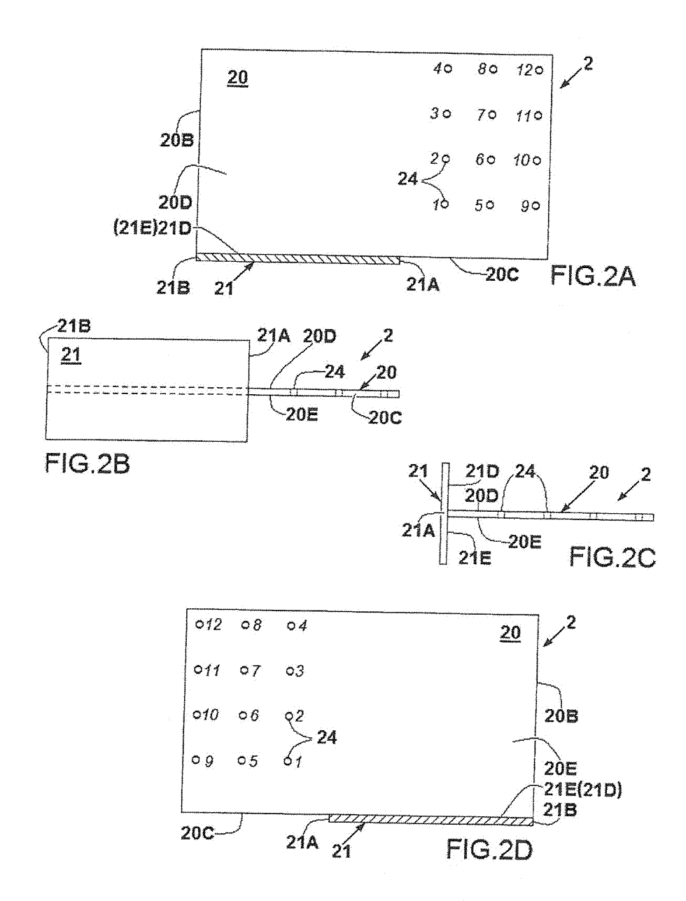

Referring to FIGS. 2A-2D, another embodiment of the mono-stable self-aligning template device 2 which may be optimized for lowest production cost and smallest size may be seen. FIG. 2A is a top view of device 2 which may consist of a plate 20 and a plate 21. Plate 21 may be perpendicular to plate 20 and is connected to plate 20 at edge 20C such that edge 21B and edge 20B may be aligned. FIG. 2B and FIG. 2C show that plate 21 may also be centered on edge 20C such that half of plate 21 is above plate 20 and the other half is below plate 20. As shown in FIG. 2A, plate 20 may have an array of two or more holes, array 24, which is located above and to the right of edge 21A by a distance of ½ inch or more in each direction. The holes in array 24 may typically be ⅛ inch in diameter, may be spaced at regular intervals of 0.5 inch or 1.0 inch when sold in the United States or other countries still using SAE measurements. If used to support countries using the metric system or for particular manufacturers products, the hole spacing and size can be easily varied. The holes in array 24 may be numbered or lettered on surface 200 as shown in FIG. 2A and on surface 20E which is the bottom side of plate 20 as shown in FIG. 2D. This embodiment of device 2 may have the lowest production cost because it can be fabricated by injection molding of low cost plastics such as acrylic, PVC, ABS or polycarbonate. In this embodiment lettering or numbering of the holes could be included in the injection mold or could be added by screening, ink-jet printing or other equivalent methods. Although this fabrication method is preferred for lowest production cost, it has substantially higher tooling cost. Custom versions for specific application may require substantial tooling charges for this embodiment as opposed to the previous embodiment and other embodiments to be disclosed below. For particular applications it may also be advantageous to fabricate device 2 out of aluminum or other metals utilizing die casting or 30 printing which also may involve higher cost tooling.

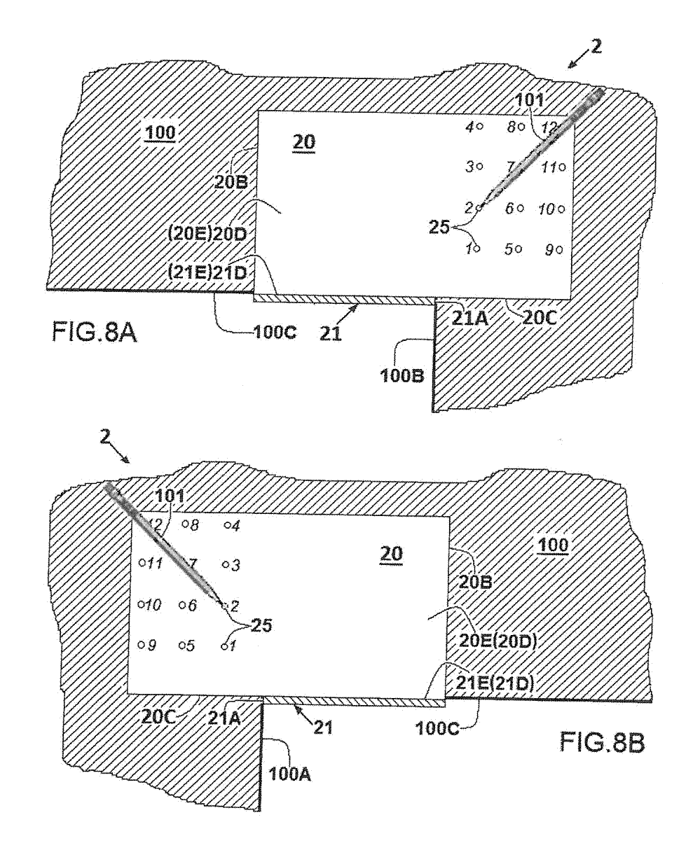

Referring to FIGS. 8A-8B, the use of the mono-stable self-aligning template device 2 on the outside of an opening in a wall may be seen. In FIG. 8A, surface 20E of plate 20 may be placed in contact with the portion of surface 100 that is adjacent to edge 100C. Device 2 may be pushed upwards to position surface 21E of plate 21 in contact with edge 100C and then moved horizontally to the right to position edge 21A in contact with edge 100B. With device 2 in the afore mentioned position, marking device 101 may be used to mark the location of the first mounting hole on surface 100: in this example hole 25-2 may be used to locate the position for mark 7R which is above and to the right of the wall opening as shown in FIG. 13A. Hole 70R may then be drilled at location 7R as shown in FIG. 13A. Right mounting bracket 93R may be positioned such that mounting bracket hole 91R may be aligned with drilled hole 70R: bracket fastener 97R may be installed through the aligned holes to partially secure the afore mentioned bracket as shown in FIG. 13B. Mounting bracket 93R may be rotated to be perpendicular to the lintel and then marking device 101 may be used to mark the location of the second mounting bracket hole on surface 100: in this example mounting bracket hole 92R may be used to locate the position for mark 9R as shown in FIG. 13B. Mounting bracket 93R may be rotated so that bracket mounting hole 90R can be drilled at location 9R as shown in FIG. 13C. The installation of the right mounting bracket may be completed by rotating it back into a vertical position and aligning bracket hole 92R with drilled hole 90R and securing it with fastener 99R as shown in FIG. 13D. If the mounting bracket had more than two holes, the additional holes may be marked and fastened in the same manner as the second mounting bracket hole as detailed above.

Referring to FIGS. 13E-13H, another method for installing the right mounting bracket may be seen. To improve accuracy, one may make a second hole mark, either above or below the first hole mark, so a straight line can be drawn as a guide for one or more of the remaining bracket holes. In this example, with device 2 in the same position used to create hole mark 7R, template hole 25-1 could be used in conjunction with marking device 101 to create mark 8R allowing straight line 95R to be drawn through said marks as shown in FIG. 13E. Hole 70R may then be drilled at location 7R as shown in FIG. 13E. Right mounting bracket 93R may be positioned such that mounting bracket hole 91R may be aligned with drilled hole 70R and bracket fastener 97R may be installed through the aligned holes to partially secure the afore mentioned bracket as shown in FIG. 13F. Mounting bracket 93R may be rotated to center bracket mounting hole 92R on line 95R and marking device 101 may be used to create hole mark 9R on surface 100 as shown in FIG. 13F. Mounting bracket 93R may then be rotated so that bracket mounting hole 90R can be drilled at location 9R as shown in FIG. 13G. The installation of the right mounting bracket may be completed by rotating it back into a vertical position and aligning bracket hole 92R with drilled hole 90R and securing it with fastener 99R as shown in FIG. 1311. If the mounting bracket had more than two holes, the additional hole(s) may be marked and fastened in the same manner as the second bracket mounting hole as detailed above.

FIG. 8B illustrates how to mark a symmetrically identical hole on the left side of the opening using device 2. In FIG. 8B, surface 20D of plate 20 may be placed in contact with the portion of surface 100 that is adjacent to edge 100C. Device 2 may be pushed upwards to position surface 21D of plate 21 in contact with edge 100C and then moved horizontally to the left to position edge 21A in contact with edge 100A. With device 2 in the afore mentioned position, marking device 101 may be used to mark the location of the first mounting hole on surface 100: in this example template hole 24-2 may be used to locate mark 7L which may be above and to the left of the wall opening as shown in FIG. 14A. Hole 70L may then be drilled at location 7L as shown in FIG. 14A. Left mounting bracket 93L may be positioned such that mounting bracket hole 91L may be aligned with drilled hole 70L and bracket fastener 97L may be installed through the aligned holes to partially secure the aforementioned bracket as shown in FIG. 14B. Mounting bracket 93L may be rotated to be perpendicular to the lintel and then marking device 101 may be used to mark the location of the second mounting bracket hole on surface 100: in this example mounting bracket hole 92L may be used to locate the position for mark 9L as shown in FIG. 14B. Mounting bracket 93L may then be rotated so that bracket mounting hole 90L can be drilled at location 9L as shown in FIG. 14C. The installation of the left mounting bracket m a y be completed by rotating it back into a vertical position and aligning bracket hole 92L with drilled hole 90L and securing it with fastener 99L as shown in FIG. 14D. If the mounting bracket had more than two holes, the additional hole(s) may be marked and fastened in the same manner as the second mounting bracket hole as detailed above.

FIGS. 14E-14H show another method for installing the left mounting bracket, that can improve accuracy. To improve accuracy, one may make a second hole mark, either above or below the first hole mark, so a straight line can be drawn as a guide for one or more of the remaining bracket holes. In this example, with device 2 in the same position used to create hole mark 7L, template hole 24-1 could be used in conjunction with marking device 101 to create mark 8L allowing straight line 95L to be drawn through said marks as shown in FIG. 14E. Hole 70L may then be drilled at location 7L as shown in FIG. 14E. Left mounting bracket 93L may be positioned such that mounting bracket hole 91L may be aligned with drilled hole 70L and bracket fastener 97L may be installed through the aligned holes to partially secure the aforementioned bracket as shown in FIG. 14F. Mounting bracket 93L may be rotated to center bracket mounting hole 92L on line 95L and marking device 101 may be used to create hole mark 9L on surface 100 as shown in FIG. 14F. Mounting bracket 93L may then be rotated so that bracket mounting hole 90L can be drilled at location 9L as shown in FIG. 14G. The installation of the left mounting bracket may be completed by rotating it back into a vertical position and aligning bracket hole 92L with drilled hole 90L and securing it with fastener 99L as shown in FIG. 1411. If the mounting bracket had more than two holes, the additional hole(s) may be marked and fastened in the same manner as the second bracket mounting hole as detailed above.

Referring to FIG. 3A-3D, another embodiment of the mono-stable self-aligning template device 3 which may have low tooling and production cost but may be harder to store or ship may be seen. FIG. 3A is a top view of device 3 which may consist of a plate 30, a plate 31, and a plate 32. Plate 31 may be perpendicular to the plate 30 and may be connected to plate 30 at edge 30C such that edge 31A and edge 30A are aligned. Plate 32 is perpendicular to plate 30 and is connected to plate 30 at edge 30F such that edge 32B and edge 30B are aligned.

FIG. 3B and FIG. 3C show that plate 31 may be bent down in the direction of surface 30E and plate 32 may be bent up in the direction of surface 30D. FIG. 3A is a top view of plate 30 and shows array 34, with two or more holes, located equidistant from edge 30C and edge 30F and also equidistant from edge 31B and edge 32A. The distances in each case would be typically ½ inch or more depending on the application. The holes in array 34 may typically be ⅛ inch in diameter, and may usually be spaced at regular intervals of 0.5 inch or 1.0 inch when sold in the United States or other countries still using SAE measurements. If used to support countries using the metric system or for particular manufacturers products, the hole spacing and size can be easily varied. The holes in array 34 may be numbered or lettered on surface 30D as shown in FIG. 3A and on surface 30E which is the bottom side of plate 30 as shown in FIG. 3D. This embodiment of device 3 may have a relatively low production cost because it can be fabricated by using water jet or laser cutting of low cost sheet plastics such as acrylic or polycarbonate. In this embodiment plate 30, plate 31, plate 32 may initially be attached and co-planer. Lettering or numbering of the holes may be added to surface 30D and surface 30E by screening, ink-jet printing or other equivalent methods before plate 31 and plate 32 may be made perpendicular to plate 30 by bending at edge 30C and 30F respectively. Although this fabrication method may be preferred for lowest tooling cost other methods such as injection molding may reduce manufacturing cost but may greatly increase tooling cost. For particular applications it may also be advantageous to fabricate device 3 out of aluminum or other metals utilizing CNC punching and bending machines or other equivalent fabrication methods.

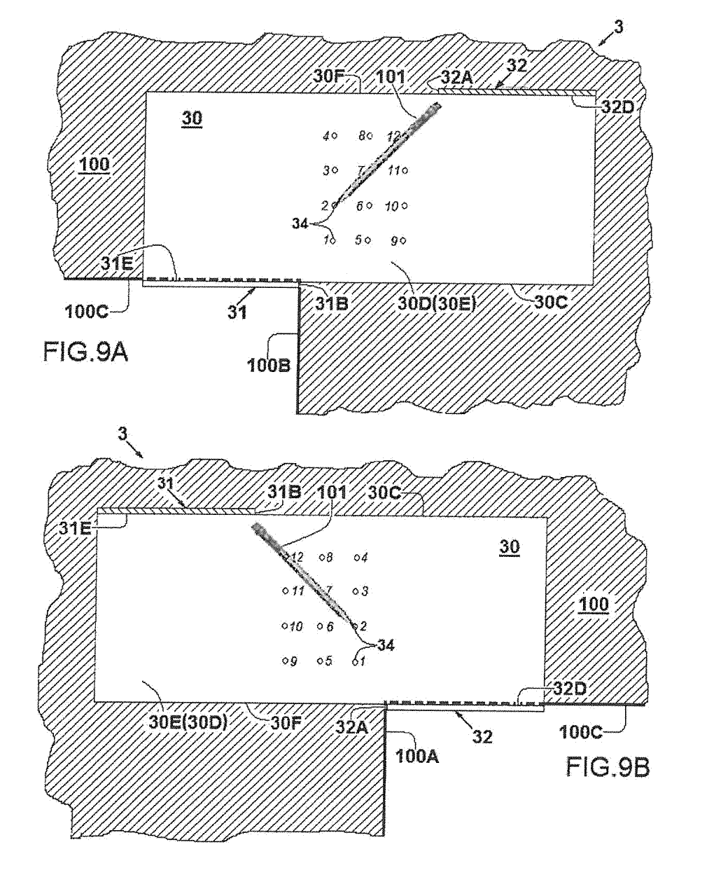

Referring to FIG. 9A-9B, the use of the mono-stable self-aligning template device 3 on the outside of an opening in a wall may be seen. In FIG. 9A, surface 30E of plate 30 of the device 3 may be placed in contact with the portion of surface 100 that is adjacent to edge 100C. Device 3 may be pushed upwards to position surface 31E of plate 31 in contact with edge 100C and then may be moved horizontally to the right to position edge 31B in contact with edge 100B. With device 3 in the aforementioned position, marking device 101 may be used to mark the location of the first mounting hole on surface 100: in this example hole 34-2 may be used to locate the position for mark 7R which may be above and to the right of the wall opening as shown in FIG. 13A. Hole 70R may then be drilled at location 7R as shown in FIG. 13A. Right mounting bracket 93R may be positioned such that mounting bracket hole 91R may be aligned with drilled hole 70R: bracket fastener 97R may be installed through the aligned holes to partially secure the aforementioned bracket as shown in FIG. 13B. Mounting bracket 93R may be rotated to be perpendicular to the lintel and then marking device 101 may be used to mark the location of the second mounting bracket hole on surface 100: in this example mounting bracket hole 92R may be used to locate the position for mark 9R as shown in FIG. 13B. Mounting bracket 93R may be rotated so that bracket mounting hole 90R can be drilled at location 9R as shown in FIG. 13C. The installation of the right mounting bracket m a y b e completed by rotating it back into a vertical position and aligning bracket hole 92R with drilled hole 90R and securing it with fastener 99R as shown in FIG. 13D. If the mounting bracket had more than two holes, the additional holes may be marked and fastened in the same manner as the second mounting bracket hole as detailed above.

FIGS. 13E-13H show another method for installing the right mounting bracket, that may improve accuracy. To improve accuracy, one may make a second hole mark, either above or below the first hole mark, so a straight line may be drawn as a guide for one or more of the remaining bracket holes. In this example, with device 3 in the same position used to create hole mark 7R, template hole 34-1 could be used in conjunction with marking device 101 to create mark 8R allowing straight line 95R to be drawn through said marks as shown in FIG. 13E. Hole 70R may then be drilled at location 7R as shown in FIG. 13E. Right mounting bracket 93R may be positioned such that mounting bracket hole 91R may be aligned with drilled hole 70R and bracket fastener 97R may be installed through the aligned holes to partially secure the aforementioned bracket as shown in FIG. 13F. Mounting bracket 93R may be rotated to center bracket mounting hole 92R on line 95R and marking device 101 may be used to create hole mark 9R on surface 100 as shown in FIG. 13F. Mounting bracket 93R may then be rotated so that bracket mounting hole 90R can be drilled at location 9R as shown in FIG. 13G. The installation of the left mounting bracket may be completed by rotating it back into a vertical position and aligning bracket hole 92R with drilled hole 90R and securing it with fastener 99R as shown in FIG. 13H. If the mounting bracket had more than two holes, the additional hole(s) may be marked and fastened in the same manner as the second bracket mounting hole as detailed above.

FIG. 9B illustrates how to mark a symmetrically identical hole on the left side of the opening using device 3. Device 3 may be rotated 180 degrees about the horizontal axis such that surface 30D may be facing surface 100. Surface 30D of plate 30 may be placed in contact with the portion of surface 100 that is adjacent to edge 100C. Device 3 may be pushed upwards to position surface 32D of plate 32 in contact with edge 100C and then moved horizontally to the left to position edge 32A in contact with edge 100A. With device 3 in the aforementioned position, marking device 101 may be used to mark the location of the first mounting hole on surface 100: in this example template hole 34-2 may be used to locate mark 7L which may be above and to the left of the wall opening as shown in FIG. 14A. Hole 70L may then be drilled at location 7L as shown in FIG. 14A. Left mounting bracket 93L may be positioned such that mounting bracket hole 91L may be aligned with drilled hole 70L and bracket fastener 97L may be installed through the aligned holes to partially secure the aforementioned bracket as shown in FIG. 14B. Mounting bracket 93L may be rotated to be perpendicular to the lintel and then marking device 101 may be used to mark the location of the second mounting bracket hole on surface 100: in this example mounting bracket hole 92L may be used to locate the position for mark 9L as shown in FIG. 14B. Mounting bracket 93L may then be rotated so that bracket mounting hole 90L can be drilled at location 9L as shown in FIG. 14C. The installation of the left mounting bracket may be completed by rotating it back into a vertical position and aligning bracket hole 92L with drilled hole 90L and securing it with fastener 99L as shown in FIG. 14D. If the mounting bracket had more than two holes, the additional hole(s) would be marked and fastened in the same manner as the second mounting bracket hole as detailed above.

FIG. 14E-14H show another method for installing the left mounting bracket, that can improve accuracy. To improve accuracy, one may make a second hole mark, either above or below the first hole mark, so a straight line can be drawn as a guide for one or more of the remaining bracket holes. In this example, with device 3 in the same position used to create hole mark 7L, template hole 34-1 could be used in conjunction with marking device 101 to create mark 8L allowing straight line 95L to be drawn through said marks as shown in FIG. 14E. Hole 70L may then be drilled at location 7L as shown in FIG. 14E. Left mounting bracket 93L may be positioned such that mounting bracket hole 91L may be aligned with drilled hole 70L and bracket fastener 97L may be installed through the aligned holes to partially secure the afore mentioned bracket as shown in FIG. 14F. Mounting bracket 93L may be rotated to center bracket mounting hole 92L on line 95L and marking device 101 may be used to create hole mark 9L on surface 100 as shown in FIG. 14F. Mounting bracket 93L may then be rotated so that bracket mounting hole 90L may be drilled at location 9L as shown in FIG. 14G. The installation of the left mounting bracket may be completed by rotating it back into a vertical position and aligning bracket hole 92L with drilled hole 90L and securing it with fastener 99L as shown in FIG. 14H. If the mounting bracket had more than two holes, the additional hole(s) may be marked and fastened in the same manner as the second bracket mounting hole as detailed above.

Referring to FIGS. 4A-4E, another embodiment of the mono-stable self-aligning template device 4 which is configured for lowest cost of tooling, simplest operation and increased flexibility may be seen. As shown in FIG. 4A and FIG. 4B, device 4 may consists of plate 40 and two self-alignment spacers, self-alignment spacer 41 and self-alignment spacer 42. FIG. 4A shows that plate 40 may have three pairs of self-alignment spacer mounting holes: preferred hole pair 48A, alternate hole-pair 48B and alternate hole-pair 48C. Plate 40 may also have two arrays of two or more holes, array 44 and array 45, that may be respectively located symmetrically equidistant from self-alignment spacer 41 and self-alignment spacer 42. The term “symmetrically equidistant” may be interpreted to mean that the arrays are a mirror image of each other and placed symmetrically with respect to the two self-alignment spacers such that array 44 is as far above and to the left of self-alignment spacer 41 as the array 45 is above and to the right of self-alignment spacer 42 as shown in FIG. 4A. The three self-alignment spacer mounting hole-pairs may allow self-alignment spacer 41 and self-alignment spacer 42 to be moved relative to array 44 and array 45 respectively which allows device 4 to mark locations that would fall in-between the array locations available with only one set of self-alignment spacer mounting holes. FIG. 4B is a front view of device 4 and shows that self-alignment spacer 41 and self-alignment spacer 42 may be perpendicular to plate 40, located on side 40E using hole-pair 48A and may be secured by screw 46 and screw 47 respectively. FIG. 4C is a bottom view of side 40E of plate 40 and shows the four mono-stable self-alignment points on self-alignment spacer 41 and self-alignment spacer 42 which are; vertical contact point 41A, vertical contact point 42A, horizontal contact point 41B and horizontal contact point 42B. FIG. 4D is an exploded view of a portion of side view 4E and shows how self-alignment spacer 42 may be secured to plate 40 using screw 47. Attaching self-alignment spacer 41 with screw 46 may be performed in the same manner. The holes in arrays 44 and array 45 may typically be ⅛ inch in diameter, may usually be spaced at regular intervals of 0.5 inch or 1.0 inch when sold in the United States or other countries still using SAE measurements. If sold or used in countries using the metric system or for particular manufacturers products, the hole spacing and size can be easily varied.

FIG. 4A shows how the holes in plate 40 could be identified. In this example, the holes in array 44 and array 45 may be numbered and the three hole-pairs may be lettered on 40D to indicate the symmetrically corresponding holes in each array and in each hole-pair. This embodiment of device 4 may have the lowest tooling cost because it can be fabricated using water jet or laser cutting of low cost sheet plastics such as acrylic or polycarbonate. After plate 40 is cut, lettering and numbering of the holes m a y b e added by screening printing, ink-jet printing or other equivalent methods before self-alignment spacer 41 and self-alignment spacer 42 are installed using screw 46 and screw 47 respectively. Although this fabrication method may have the lowest tooling cost, other methods such as injection molding m a y reduce manufacturing cost but may greatly increase tooling cost. For particular applications it may also be advantageous to fabricate device 4 out of aluminum or other metals utilizing CNC punching and bending machines or other equivalent fabrication methods.

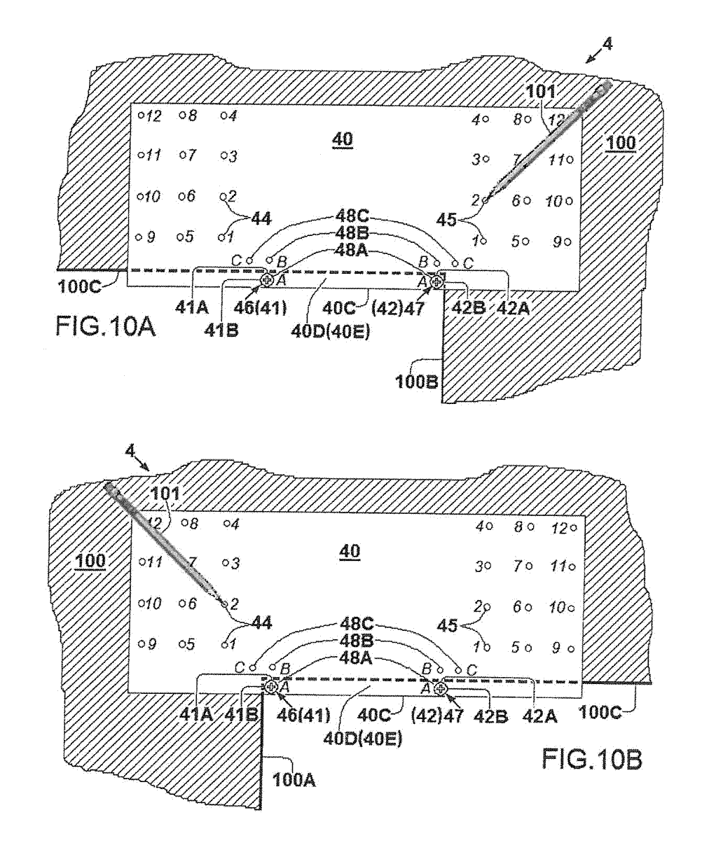

Referring to FIG. 10A-10B, the use of the mono-stable self-aligning template device 4 on the outside of an opening in a wall may be shown. In FIG. 10A, surface 40E of plate 40 may be placed in contact with the portion of surface 100 that is adjacent to edge 100C. Device 4 may be pushed upwards to position vertical contact point 41A and vertical contact point 42A, in contact with edge 100C and then moved horizontally to the right to position horizontal contact 42B in contact with edge 100B. With device 4 in the aforementioned position, marking device 101 may be used to mark the location of the first mounting hole on surface 100: in this example hole 45-2 may be used to locate the position for mark 7R which is above and to the right of the wall opening as shown in FIG. 13A. Hole 70R may then be drilled at location 7R as shown in FIG. 13A. Right mounting bracket 93R may be positioned such that mounting bracket hole 91R may be aligned with drilled hole 70R: bracket fastener 97R may be installed through the aligned holes to partially secure the afore mentioned bracket as shown in FIG. 13B. Mounting bracket 93R may be rotated to be perpendicular to the lintel and then marking device 101 may be used to mark the location of the second mounting bracket hole on surface 100: in this example mounting bracket hole 92R may be used to locate the position for mark 9R as shown in FIG. 13B. Mounting bracket 93R may be rotated so that bracket mounting hole 90R can be drilled at location 9R as shown in FIG. 13C. The installation of the right mounting bracket may be completed by rotating it back into a vertical position and aligning bracket hole 92R with drilled hole 90R and securing it with fastener 99R as shown in FIG. 13D. If the mounting bracket had more than two holes, the additional holes may be marked and fastened in the same manner as the second mounting bracket hole as detailed above.

FIGS. 13E-13H show another method for installing the right mounting bracket, that may improve accuracy. To improve accuracy, one may make a second hole mark, either above or below the first hole mark, so a straight line can be drawn as a guide for one or more of the remaining bracket holes. In this example, with device 4 in the same position used to create hole mark 7R, template hole 45-1 could be used in conjunction with marking device 101 to create mark 8R allowing straight line 95R to be drawn through said marks as shown in FIG. 13E. Hole 70R may then be drilled at location 7R as shown in FIG. 13E. Right mounting bracket 93R may be positioned such that mounting bracket hole 91R may be aligned with drilled hole 70R and bracket fastener 97R may be installed through the aligned holes to partially secure the aforementioned bracket as shown in FIG. 13F. Mounting bracket 93R may be rotated to center bracket mounting hole 92R on line 95R and marking device 101 may be used to create hole mark 9R on surface 100 as shown in FIG. 13F. Mounting bracket 93R may then be rotated so that bracket mounting hole 90R can be drilled at location 9R as shown in FIG. 13G. The installation of the left mounting bracket may be completed by rotating it back into a vertical position and aligning bracket hole 92R with drilled hole 90R and securing it with fastener 99R as shown in FIG. 13H. If the mounting bracket had more than two holes, the additional hole(s) may be marked and fastened in the same manner as the second bracket mounting hole as detailed above.

FIG. 10B illustrates how to mark a symmetrically identical hole on the left side of the opening using device 4. In FIG. 10B, surface 40E of plate 40 may be placed in contact the portion of surface 100 that is adjacent to edge 100C. Device 4 may be pushed upwards to position vertical contact point 41A and vertical contact point 42A in contact with edge 100C and then moved horizontally to the left to position horizontal contact point 41B in contact with edge 100A. With device 4 in the aforementioned position, marking device 101 may be used to mark the location of the first mounting hole on surface 100: in this example template hole 44-2 may be used to locate mark 7L which is above and to the left of the wall opening as shown in FIG. 14A. Hole 70L may then be drilled at location 7L as shown in FIG. 14A. Left mounting bracket 93L may be positioned such that mounting bracket hole 91L may be aligned with drilled hole 70L and bracket fastener 97L may be installed through the aligned holes to partially secure the aforementioned bracket as shown in FIG. 14B. Mounting bracket 93L may be rotated to be perpendicular to the lintel and then marking device 101 may be used to mark the location of the second mounting bracket hole on surface 100: in this example mounting bracket hole 92L may be used to locate the position for mark 9L as shown in FIG. 14B. Mounting bracket 93L may then be rotated so that bracket mounting hole 90L can be drilled at location 9L as shown in FIG. 14C. The installation of the left mounting bracket may be completed by rotating it back into a vertical position and aligning bracket hole 92L with drilled hole 90L and securing it with fastener 99L as shown in FIG. 14D. If the mounting bracket had more than two holes, the additional hole(s) may be marked and fastened in the same manner as the second mounting bracket hole as detailed above.

FIGS. 14E-14H show another method for installing the left mounting bracket, that can improve accuracy. To improve accuracy, one may make a second hole mark, either above or below the first hole mark, so a straight line can be drawn as a guide for one or more of the remaining bracket holes. In this example, with device 4 in the same position used to create hole mark 7L, template hole 44-1 could be used in conjunction with marking device 101 to create mark 8L allowing straight line 95L to be drawn through said marks as shown in FIG. 14E. Hole 70L may then be drilled at location 7L as shown in FIG. 14E. Left mounting bracket 93L may be positioned such that mounting bracket hole 91L may be aligned with drilled hole 70L and bracket fastener 97L may be installed through the aligned holes to partially secure the aforementioned bracket as shown in FIG. 14F. Mounting bracket 93L may be rotated to center bracket mounting hole 92L on line 95L and marking device 101 may be used to create hole mark 9L on surface 100 as shown in FIG. 14F. Mounting bracket 93L may then be rotated so that bracket mounting hole 90L can be drilled at location 9L as shown in FIG. 14G. The installation of the left mounting bracket may be completed by rotating it back into a vertical position and aligning bracket hole 92L with drilled hole 90L and securing it with fastener 99L as shown in FIG. 14H. If the mounting bracket had more than two holes, the additional hole(s) may be marked and fastened in the same manner as the second bracket mounting hole as detailed above.

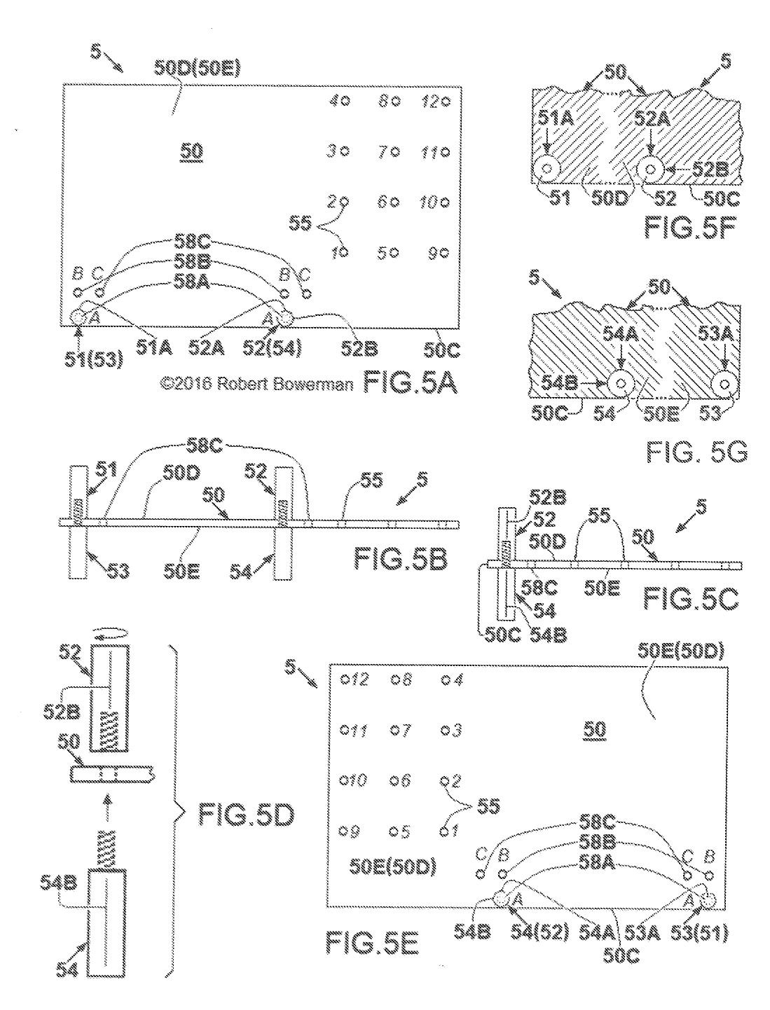

FIGS. 5A-5G show another preferred embodiment of the mono-stable self-alignment template device 5 which may be configured for lowest production cost, smallest size and increased flexibility. As shown in FIG. 5A and FIG. 5B, device 5 may consists of plate 50 and four self-alignment spacers perpendicular to plate 50: self-alignment spacer 51 and self-alignment spacer 52, located on side 50D; self-alignment spacer 53 and self-alignment spacer 54 located on side 50E. Top view FIG. 5A shows that plate 50 may have three pairs of self-alignment spacer mounting holes: preferred hole-pair 58A, alternate hole-pair 58B and alternate hole-pair 58C. As shown in FIG. 5A, plate 50 may also have an array of two or more holes, array 55, which is located above and to the right of self-alignment spacers 52 by a distance of ½ inch or more in each direction depending on the application. The three self-alignment spacer mounting hole-pairs may allow the four self-alignment spacers to be moved relative to array 54 which allows device 5 to mark locations that would fall in between the array locations available with only one set of self-alignment spacer mounting holes. The spacing between self-alignment spacer mounting hole pairs may normally be half of the distance between holes in array 55 but could be changed depending on the application. More alternate self-alignment spacer mounting holes can be added if desired for additional flexibility. FIG. 5B is a front view of device 5 and shows that self-alignment spacer 51 and self-alignment spacer 52 may have female threads: self-alignment spacer 53 and self-alignment spacer 54 may have male threads: each co-located male/female self-alignment spacer-pair may occupy one of the holes in preferred hole-pair 58A. FIG. 5A and FIG. 5F show that self-alignment spacer 51 and self-alignment spacer 52, together may define three self-alignment points on side 50D; vertical alignment point 51A, vertical alignment point 52A and horizontal alignment point 52B. FIG. 5E and FIG. 5G show that self-alignment spacer 53 and self-alignment spacer 54, together may define three self-alignment points on side 50E: vertical alignment point 53A, vertical alignment point 54A and horizontal alignment point 54B. FIG. 5C is a side view of device 5 and shows self-alignment spacer 52 and self-alignment spacer 54 connected through a hole in plate 50; said hole may be part of preferred hole-pair 58A. Exploded view FIG. 5D shows the assemble process for one of the co-located male/female self-alignment spacer-pair: male self-alignment spacer 54 may be pushed through the aforementioned hole in plate 50 and then female self-alignment spacer 52 may be placed in contact with male fourth self-alignment spacer 54 and rotated clockwise until tight. The other co-located male/female self-alignment spacer-pair, male self-alignment spacer 53 and female self-alignment spacer 54 may be assembled in the same manner. The holes in array 54 may typically be ⅛ inch in diameter, may usually be spaced at regular intervals of 0.5 inch or 1.0 inch when sold in the United States or other countries still using SAE measurements. If used to support countries using the metric system or for particular manufacturers products, the hole spacing and size can be easily varied. The holes in array 54 may be numbered or lettered on surface 50D as shown in FIG. 5A and on surface 50E which is the bottom side of plate 50 as shown in FIG. 5E such that the same number labels the same hole on each side of plate 50. This embodiment of device 5 may have the lowest tooling cost because it can be fabricated using water jet or laser cutting of low cost sheet plastics such as acrylic or polycarbonate. After plate 50 is cut, lettering and numbering of the holes may be added by screening printing, ink-jet printing or other equivalent methods before any of the self-alignment spacer are installed. To minimize shipping and storage cost, the four self-alignment spacers could be shipped unassembled with instructions added to the user instruction sheet. Although this fabrication method may have the lowest tooling cost, other methods such as injection molding may likely reduce manufacturing cost but would greatly increase tooling cost. For particular applications it may also be advantageous to fabricate device 5 out of aluminum or other metals utilizing CNC punching and bending machines or other equivalent fabrication methods.

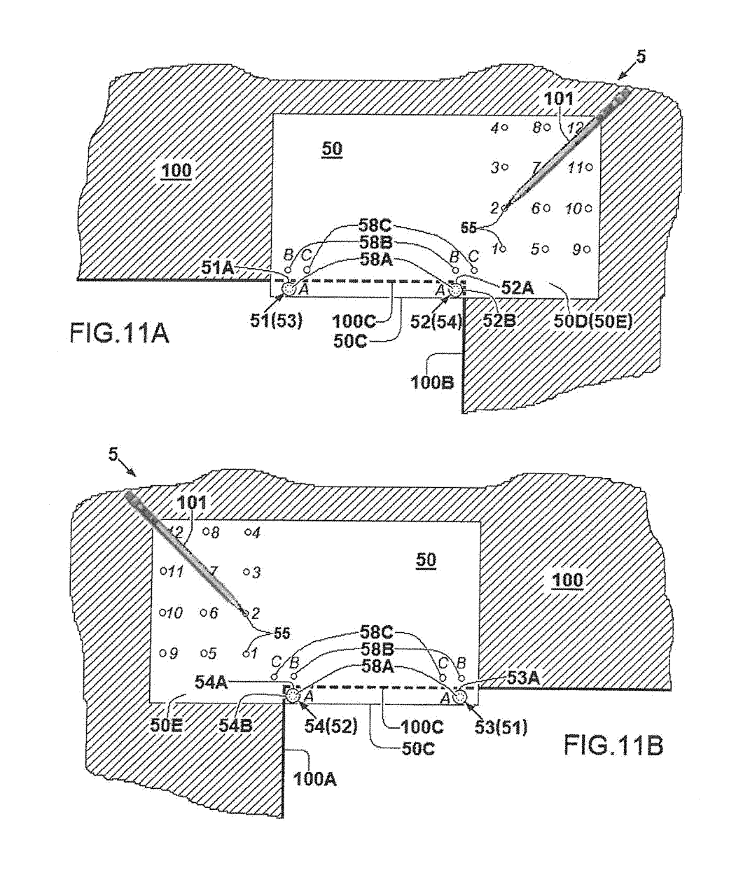

FIG. 11A-11B illustrate the use of the mono-stable self-aligning template device 5 on the outside of an opening in a wall. In FIG. 11A, surface 50E of plate 50 of the device 5 may be placed in contact with the portion of surface 100 that is adjacent to edge 100C. Device 5 may be pushed upwards to position vertical alignment point 53A and vertical alignment point 54A in contact with edge 100C and then moved horizontally to the right to position horizontal alignment point 54B in contact with edge 100B. With device 5 in the aforementioned position, marking device 101 may be used to mark the location of the first mounting hole on surface 100: in this example hole 55-2 may be used to locate the position for mark 7R which is above and to the right of the wall opening as shown in FIG. 13A. Hole 70R may then be drilled at location 7R as shown in FIG. 13A. Right mounting bracket 93R may be positioned such that mounting bracket hole 91R may be aligned with drilled hole 70R: bracket fastener 97R may be installed through the aligned holes to partially secure the aforementioned bracket as shown in FIG. 13B. Mounting bracket 93R may be rotated to be perpendicular to the lintel and then marking device 101 may be used to mark the location of the second mounting bracket hole on surface 100: in this example mounting bracket hole 92R may be used to locate the position for mark 9R as shown in FIG. 13B. Mounting bracket 93R may be rotated so that bracket mounting hole 90R can be drilled at location 9R as shown in FIG. 13C. The installation of the right mounting bracket may be completed by rotating it back into a vertical position and aligning bracket hole 92R with drilled hole 90R and securing it with fastener 99R as shown in FIG. 13D. If the mounting bracket had more than two holes, the additional holes may be marked and fastened in the same manner as the second mounting bracket hole as detailed above.

FIGS. 13E-13H show another method for installing the right mounting bracket, that can improve accuracy. To improve accuracy, one may make a second hole mark, either above or below the first hole mark, so a straight line can be drawn as a guide for one or more of the remaining bracket holes. In this example, with device 5 in the same position used to create hole mark 7R, template hole 55-1 could be used in conjunction with marking device 101 to create mark 8R allowing straight line 95R to be drawn through said marks as shown in FIG. 13E. Hole 70R may then be drilled at location 7R as shown in FIG. 13E. Right mounting bracket 93R may be positioned such that mounting bracket hole 91R may be aligned with drilled hole 70R and bracket fastener 97R may be installed through the aligned holes to partially secure the aforementioned bracket as shown in FIG. 13F. Mounting bracket 93R may be rotated to center bracket mounting hole 92R on line 95R and marking device 101 may be used to create hole mark 9R on surface 100 as shown in FIG. 13F. Mounting bracket 93R may then be rotated so that bracket mounting hole 90R can be drilled at location 9R as shown in FIG. 13G. The installation of the left mounting bracket may be completed by rotating it back into a vertical position and aligning bracket hole 92R with drilled hole 90R and securing it with fastener 99R as shown in FIG. 13H. If the mounting bracket had more than two holes, the additional hole(s) may be marked and fastened in the same manner as the second bracket mounting hole as detailed above.

FIG. 11B illustrates how to mark a symmetrically identical hole on the left side of the opening using device 5. In FIG. 11B, surface 50D of plate 50 may be placed in contact the portion of surface 100 that is adjacent to edge 100C. Device 5 may be pushed upwards to position vertical alignment point 51A and vertical alignment point 52A in contact with edge 100C and then moved horizontally to the left to position horizontal alignment point 52B in contact with edge 100A. With device 5 in the aforementioned position, marking device 101 may be used to mark the location of the first mounting hole on surface 100: in this example template hole 55-2 may be used to locate mark 7L which is above and to the left of the wall opening as shown in FIG. 14A. Hole 70L may then be drilled at location 7L as shown in FIG. 14A. Left mounting bracket 93L may be positioned such that mounting bracket hole 91L may be aligned with drilled hole 70L and bracket fastener 97L may be installed through the aligned holes to partially secure the aforementioned bracket as shown in FIG. 14B. Mounting bracket 93L may be rotated to be perpendicular to the lintel and then marking device 101 may be used to mark the location of the second mounting bracket hole on surface 100: in this example mounting bracket hole 92L may be used to locate the position for mark 9L as shown in FIG. 14B. Mounting bracket 93L may then be rotated so that bracket mounting hole 90L can be drilled at location 9L as shown in FIG. 14C. The installation of the left mounting bracket may be completed by rotating it back into a vertical position and aligning bracket hole 92L with drilled hole 90L and securing it with fastener 99L as shown in FIG. 14D. If the mounting bracket had more than two holes, the additional hole(s) may be marked and fastened in the same manner as the second mounting bracket hole as detailed above.

FIGS. 14E-14H show another method for installing the left mounting bracket, that can improve accuracy. To improve accuracy, one may make a second hole mark, either above or below the first hole mark, so a straight line can be drawn as a guide for one or more of the remaining bracket holes. In this example, with device 5 in the same position used to create hole mark 7L, template hole 55-1 could be used in conjunction with marking device 101 to create mark 8L allowing straight line 95L to be drawn through said marks as shown in FIG. 14E. Hole 70L may then be drilled at location 7L as shown in FIG. 14E. Left mounting bracket 93L may be positioned such that mounting bracket hole 91L may be aligned with drilled hole 70L and bracket fastener 97L may be installed through the aligned holes to partially secure the afore mentioned bracket as shown in FIG. 14F. Mounting bracket 93L may be rotated to center bracket mounting hole 92L on line 95L and marking device 101 may be used to create hole mark 9L on surface 100 as shown in FIG. 14F. Mounting bracket 93L may then be rotated so that bracket mounting hole 90L can be drilled at location 9L as shown in FIG. 14G. The installation of the left mounting bracket may be completed by rotating it back into a vertical position and aligning bracket hole 92L with drilled hole 90L and securing it with fastener 99L as shown in FIG. 14H. If the mounting bracket had more than two holes, the additional hole(s) may be marked and fastened in the same manner as the second bracket mounting hole as detailed above.

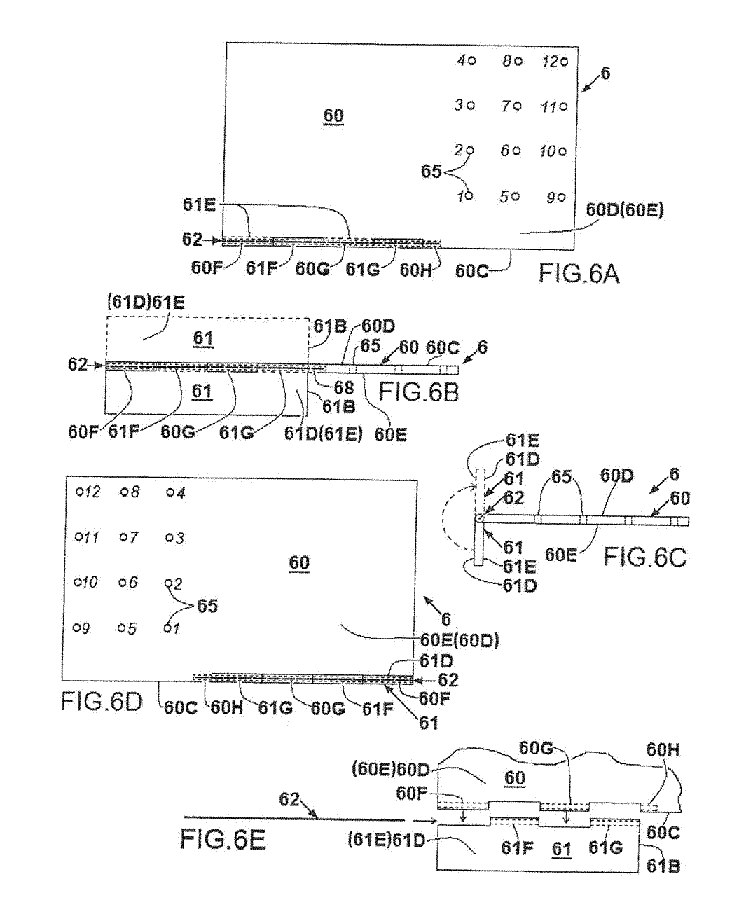

FIGS. 6A-6E show another embodiment of the mono-stable self-aligning template device 6 which may be configured for minimum shipping and storage size. FIG. 6A is a top view of device 6 which may consists of a plate 60 and a plate 61 which may be perpendicular to the plate 60 and may be connected to plate 60 at edge 60C such that lateral hole 60F, hole 60G and 60H of plate 60 may be aligned with hole 61F and 61G of plate 61. FIG. 6E shows plate 60 and plate 61 being aligned and then joined by inserting hinge-pin 62. FIG. 6B and FIG. 6C show that plate 61 may rotate around edge 60C and may have two operating position that are perpendicular to plate 60. The position used for locating mounting hole on the right side of and opening may be shown with solid lines and extends downward toward side 60E and the position used to locate mounting holes on the left side of an opening may be shown in dashed lines and extends upward toward side 60E as shown in FIG. 60B and FIG. 60C.

Plate 60 may also have an array of two or more holes, array 65, which may be located above and to the right of edge 61B by a distance of ½ inch or more in each direction as seen in FIG. 6A. The same, array 65, may be seen in FIG. 6D located above and to the left of edge 61B. The holes in array 65 may typically be ⅛ inch in diameter, and may usually be spaced at regular intervals of 0.5 inch or 1.0 inch when sold in the United States or other countries still using SAE measurements. If used to support countries using the metric system or for particular manufacturers products, the hole spacing and size can be easily varied. The holes in array 65 may be numbered or lettered on surface 60D as shown in FIG. 6A and on surface 60E which may be the bottom side of plate 60 as shown in FIG. 6D. This embodiment of device 6 may have the minimum shipping and storage size but also may have the highest tooling and production cost because it would require relatively complicated tooling for injection molding. Device 6 could be molded of low cost plastics such as acrylic, PVC, ABS or polycarbonate. In this embodiment lettering or numbering of the holes could be included in the injection mold or could be added by screening, ink-jet printing or other equivalent methods. Custom versions for specific application may require substantial tooling charges for this embodiment as opposed to embodiments previously disclosed. For particular applications it may also be advantageous to fabricate device 6 out of aluminum or other metals utilizing die casting, metal stamping or 3D printing, however, these methods may involve higher cost tooling.

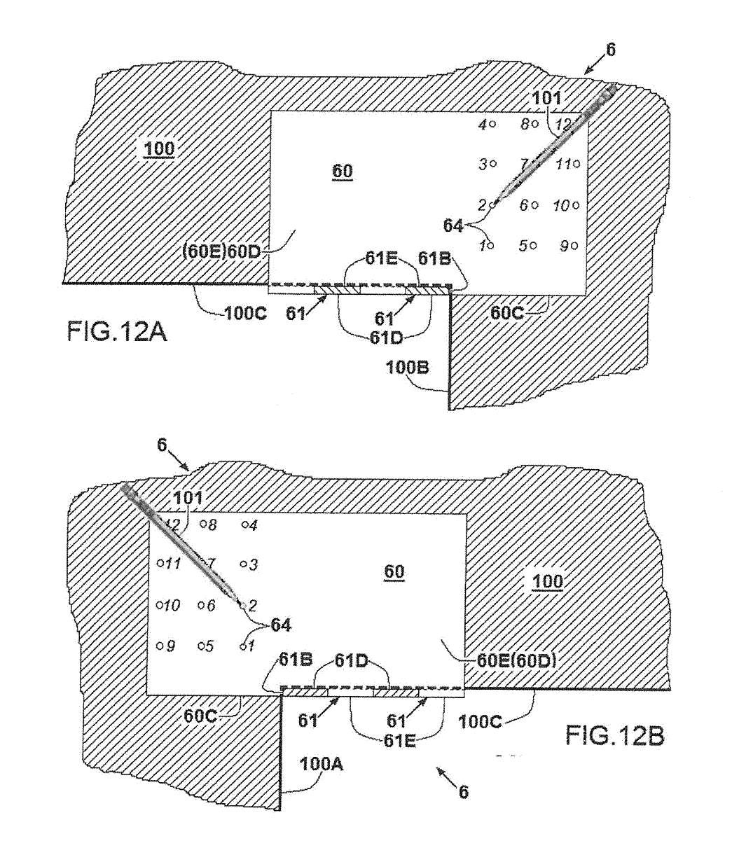

FIGS. 12A-12B illustrate the use of the mono-stable self-aligning template device 6 on the outside of an opening in a wall. Plate 61 of device 6 may be rotated in the direction of surface 60E as shown in FIG. 6B and FIG. 6C as the solid line outline in the downward direction. In FIG. 12A, surface 60E of plate 60 may be placed in contact with the portion of surface 100 that is adjacent to edge 100C. Device 6 may be pushed upwards to position surface 61E of plate 61 in contact with edge 100C and then moved horizontally to the right to position edge 61B in contact with edge 100B. With device 6 in the aforementioned position, marking device 101 may be used to mark the location of the first mounting hole on surface 100: in this example hole 65-2 may be used to locate the position for mark 7R which is above and to the right of the wall opening as shown in FIG. 13A. Hole 70R may then be drilled at location 7R as shown in FIG. 13A. Right mounting bracket 93R may be positioned such that mounting bracket hole 91R may be aligned with drilled hole 70R: bracket fastener 97R may be installed through the aligned holes to partially secure the aforementioned bracket as shown in FIG. 13B. Mounting bracket 93R may be rotated to be perpendicular to the lintel and then marking device 101 may be used to mark the location of the second mounting bracket hole on surface 100: in this example mounting bracket hole 92R may be used to locate the position for mark 9R as shown in FIG. 13B. Mounting bracket 93R may be rotated so that bracket mounting hole 90R may be drilled at location 9R as shown in FIG. 13C. The installation of the right mounting bracket may be completed by rotating it back into a vertical position and aligning bracket hole 92R with drilled hole 90R and securing it with fastener 99R as shown in FIG. 13D. If the mounting bracket had more than two holes, the additional holes may be marked and fastened in the same manner as the second mounting bracket hole as detailed above.

FIGS. 13E-13H show another method for installing the right mounting bracket, that can improve accuracy. To improve accuracy, one may make a second hole mark, either above or below the first hole mark, so a straight line can be drawn as a guide for one or more of the remaining bracket holes. In this example, with device 6 in the same position used to create hole mark 7R, template hole 65-1 could be used in conjunction with marking device 101 to create mark 8R allowing straight line 95R to be drawn through said marks as shown in FIG. 13E. Hole 70R may then be drilled at location 7R as shown in FIG. 13E. Right mounting bracket 93R may be positioned such that mounting bracket hole 91R may be aligned with drilled hole 70R and bracket fastener 97R may be installed through the aligned holes to partially secure the aforementioned bracket as shown in FIG. 13F. Mounting bracket 93R may be rotated to center bracket mounting hole 92R on line 95R and marking device 101 may be used to create hole mark 9R on surface 100 as shown in FIG. 13F. Mounting bracket 93R may then be rotated so that bracket mounting hole 90R can be drilled at location 9R as shown in FIG. 13G. The installation of the left mounting bracket may be completed by rotating it back into a vertical position and aligning bracket hole 92R with drilled hole 90R and securing it with fastener 99R as shown in FIG. 13H. If the mounting bracket had more than two holes, the additional hole(s) may be marked and fastened in the same manner as the second bracket mounting hole as detailed above.

FIG. 12B illustrates how to mark a symmetrically identical hole on the left side of the opening using device 6. Plate 61 of device 6 may be rotated in the direction of surface 60D as shown in FIG. 6B as the dashed-line outline in the upward direction. In FIG. 12B, surface 60D of plate 60 may be placed in contact with the portion of surface 100 that is adjacent to edge 100C. Device 6 may be pushed upwards to position surface 61D of plate 61 in contact with edge 100C and then moved horizontally to the left to position edge 61B in contact with edge 100A. With device 6 in the aforementioned position, marking device 101 may be used to mark the location of the first mounting hole on surface 100: in this example template hole 63-2 may be used to locate mark 7L which may be above and to the left of the wall opening as shown in FIG. 14A. Hole 70L may then be drilled at location 7L as shown in FIG. 14A. Left mounting bracket 93L may be positioned such that mounting bracket hole 91L is aligned with drilled hole 70L and bracket fastener 97L may be installed through the aligned holes to partially secure the aforementioned bracket as shown in FIG. 14B. Mounting bracket 93L may be rotated to be perpendicular to the lintel and then marking device 101 may be used to mark the location of the second mounting bracket hole on surface 100: in this example mounting bracket hole 92L may be used to locate the position for mark 9L as shown in FIG. 14B. Mounting bracket 93L may then be rotated so that bracket mounting hole 90L can be drilled at location 9L as shown in FIG. 14C. The installation of the left mounting bracket may be completed by rotating it back into a vertical position and aligning bracket hole 92L with drilled hole 90L and securing it with fastener 99L as shown in FIG. 14D. If the mounting bracket has more than two holes, the additional hole(s) may be marked and fastened in the same manner as the second mounting bracket hole as detailed above.

FIGS. 14E-14H show another method for installing the left mounting bracket, that can improve accuracy. To improve accuracy, one m a y make a second hole mark, either above or below the first hole mark, so a straight line can be drawn as a guide for one or more of the remaining bracket holes. In this example, with device 6 in the same position used to create hole mark 7L, template hole 63-1 could be used in conjunction with marking device 101 to create mark 8L allowing straight line 95L to be drawn through said marks as shown in FIG. 14E. Hole 70L may then be drilled at location 7L as shown in FIG. 14E. Left mounting bracket 93L may be positioned such that mounting bracket hole 91L may be aligned with drilled hole 70L and bracket fastener 97L may be installed through the aligned holes to partially secure the afore mentioned bracket as shown in FIG. 14F. Mounting bracket 93L may be rotated to center bracket mounting hole 92L on line 95L and marking device 101 may be used to create hole mark 9L on surface 100 as shown in FIG. 14F. Mounting bracket 93L may then be rotated so that bracket mounting hole 90L can be drilled at location 9L as shown in FIG. 14G. The installation of the left mounting bracket may be completed by rotating it back into a vertical position and aligning bracket hole 92L with drilled hole 90L and securing it with fastener 99L as shown in FIG. 14H. If the mounting bracket had more than two holes, the additional hole(s) may be marked and fastened in the same manner as the second bracket mounting hole as detailed above.

While embodiments of the disclosure have been described in terms of various specific embodiments, those skilled in the art will recognize that the embodiments of the disclosure can be practiced with modifications within the spirit and scope of the claims.

What is claimed is:

1. A mono-stable self-aligning template for installing brackets and treatments around an opening comprising:
a first plate having a top surface, a bottom surface, a front edge, a rear edge and a pair of opposing side edges;
a plurality of openings formed through the top surface of the first plate, the plurality of openings arranged in at least a first array on a first side area on the top surface of the first plate; and
a mono-stable self-alignment device coupled to the first plate, the mono-stable self-alignment device being perpendicular to the first plate.

2. The mono-stable self-aligning template of claim 1, wherein the plurality of openings is spaced at equal intervals using Society of Automotive Engineers (SAE) measurement system.

3. The mono-stable self-aligning template of claim 1, wherein the plurality of openings is spaced at equal intervals using metric measurement system.

4. The mono-stable self-aligning template of claim 2, wherein each of the plurality of openings are ⅛″ in diameter and spaced at least ½″ apart from one another.

5. The mono-stable self-aligning template of claim 1, wherein the plurality of openings is positioned at least ½″ above the front edge.

6. The mono-stable self-aligning template of claim 1, comprising indicia formed next to each of the plurality of openings.

7. The mono-stable self-aligning template of claim 6, wherein the indicia are formed next to each of the plurality of openings on both the top surface and bottom surface of the first plate.

8. The mono-stable self-aligning template of claim 1, wherein the mono-stable self-alignment device is attached to the front edge of the first plate, the mono-stable self-alignment device positioned in front of a second side area of the top surface, the second side area opposite the first side area.

9. The non-stable self-aligning template of claim 1, wherein the mono-stable self-alignment device is a second plate, the second plate attached to the front edge of the first plate and positioned in front of a second side area of the top surface, the second side area opposite the first side area, the second plate extending an equal distant above and below the front edge.

10. The mono-stable self-aligning template of claim 8, wherein the first plate and second plate are formed of one of: a plastic material or a light weight metal material.

11. A method for installing items around an opening comprising:
providing a mono-stable self-aligning template comprising:
a first plate having a top surface, a bottom surface, a front edge, a rear edge and a pair of opposing side edges;
a plurality of openings formed through the top surface of the first plate, the plurality of openings arranged in at least a first array on a first side area on the top surface of the plate;
indicia formed next to each of the plurality of openings on both the top and bottom surfaces of the first plate; and
a mono-stable self-alignment device coupled to the first plate, wherein the mono-stable self-alignment device is a second plate, the second plate attached to the front edge of the first plate and positioned in front of a second side area of the top surface, the second side area opposite the first side area, the second plate extending an equal distant above and below the front edge, the second plate being perpendicular to the top surface and the rear surface of the first plate;
placing the bottom surface of the first plate against a wall where the opening is formed;
moving the mono-stable self-aligning template until the second plate touches an upper ledge of the opening and a right-side ledge of the opening;
marking a first drill hole location by inserting a marking device through a selected opening of the plurality of openings;
placing the top surface of the first plate against the wall where the opening is formed;
moving the mono-stable self-aligning template until the second plate touches the upper ledge of the opening and a left-side ledge of the opening; and
marking a second drill hole location by inserting the marking device through the selected opening of the plurality of openings.

12. The method of claim 11, comprising:
drilling the first drill hole; and
securing a first mounting bracket to the first drill hole.

13. The method of claim 12, wherein securing the first mounting bracket comprises:
aligning a first mounting bracket hole of the first mounting bracket with the first drill hole;
partially securing a first mounting bracket fastener into the first mounting bracket hole of the first mounting bracket;
marking a second mounting bracket hole of the first mounting bracket by inserting the marking device through a second mounting bracket hole in the first mounting bracket;
drilling the second mounting bracket hole; and
securing a second mounting bracket fastener into the second mounting bracket hole of the first mounting bracket.

14. The method of claim 13, comprising:
drilling the second drill hole; and
securing a second mounting bracket to the second drill hole.

15. The method of claim 14, wherein securing the first mounting bracket comprises:
aligning a first mounting bracket hole of the second mounting bracket with the second drill hole;
partially securing a third mounting bracket fastener into the first mounting bracket hole of the second mounting bracket;
marking a second mounting bracket hole of the second mounting bracket by inserting the marking device through a second mounting bracket hole in the second mounting bracket;
drilling the second mounting bracket hole of the second mounting bracket; and
securing a fourth mounting bracket fastener into the second mounting bracket hole of the second mounting bracket.

16. A mono-stable self-aligning template for installing brackets and treatments around an opening comprising:
a first plate having a top surface, a bottom surface, a front edge, a rear edge and a pair of opposing side edges;
a plurality of openings formed through the top surface of the first plate, the plurality of openings arranged in at least a first array on a first side area on the top surface of the first plate;
indicia formed next to each of the plurality of openings on both the front and rear surfaces of the first plate, wherein the indicia formed next to each of the plurality of openings on the front surface matches the indicia formed next to each of the plurality of openings on the rear surface; and
a mono-stable self-alignment device coupled to the first plate, wherein the mono-stable self-alignment device is a second plate, the second plate attached to the front edge of the first plate and positioned in front of a second side area of the top surface, the second side area opposite the first side area, the second plate extending an equal distant above and below the front edge, the second plate being perpendicular to the top surface and the rear surface of the first plate.

17. The mono-stable self-aligning template of claim 16, wherein the plurality of openings is positioned at least ½″ above the front edge.

18. The mono-stable self-aligning template of claim 16, wherein the first plate and second plate are formed of one of a plastic material or a light weight metal material.

19. The mono-stable self-aligning template of claim 16, wherein the plurality of openings is spaced at equal intervals using Society of Automotive Engineers (SAE) measurement system.

20. The mono-stable self-aligning template of claim 16, wherein the plurality of openings is spaced at equal intervals using metric measurement system.
